(19) United States
(12) Patent Application Publication
(10) Pub. No.: US 2009/0075675 A1
(43) Pub. Date: Mar. 19, 2009

(54) METHOD OF LOCATION BASED SERVICE AND LOCATION BASED SERVICE SYSTEM

(75) Inventors: Tae Il Kim, Seoul (KR); Tae Joon Ha, Gyeonggi-do (KR); Jeong Yun Hwang, Gyeonggi-do (KR); Eun Young Kim, Seoul (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: RADIANT TECHNOLOGIES, INC, Seoul (KR)

(21) Appl. No.: 12/299,379

(22) PCT Filed: Apr. 12, 2007
(86) PCT No.: PCT/KR07/01787

§ 371 Date: Nov. 3, 2008

(30) Foreign Application Priority Data
May 4, 2006 (KR) 10-2006-0040410

(51) Int. Cl. H04W 24/00; G01S 1/00

(52) U.S. Cl. 455/456.2; 342/357.09

(57) ABSTRACT

A location based service method and location based service system is provided. The location based service method includes: making requests for position determination of a client terminal according to a first position determination method and a second position determination method, in response to a location based service request; receiving a position determination result according to the first position determination method, and generating first location data including additional information which corresponds to the position determination result according to the first position determination method; providing the client terminal with the first location data; receiving a position determination result according to the second position determination method, and generating second location data, the second location data being refined first location data; and providing the client terminal with the second location data.

### TECHNICAL FIELD

The present invention relates to a location based service method, and more particularly, to a location based service method and system using the method which provides a client terminal with each position determination result, having been position-determined according to a first position determination method and a second position determination, in response to a location based service request.

### BACKGROUND ART

Recently, various services based on a location of a mobile communication terminal have been developed. That is, information associated with a present location is rapidly and easily provided to a user which carries the mobile communication terminal. Specifically, traffic information concerning traffic, surrounding area information giving information for preventing accidents and assisting in disasters, tourist information for leisure, and the like, may be provided. Also, services such as a mobile commerce for shopping for local specialty goods and souvenirs, for on-the-spot ticket purchasing, and for distribution control of freight and vehicle tracking may be provided based on a location of a mobile communication terminal.

A mobile terminal moving within a mobile communication network communicates with a plurality of base stations by exchanging unique identification information. In relation to the plurality of base stations, various technologies are developed to determine a location of the mobile terminal.

As an example, in a network-based position determination technology, there are a cell ID, TruePosition, Inc.'s Time Difference of Arrival (U-TDOA), Time Difference of Arrival (TDOA), and QUALCOMM/SnapTrack Inc.'s Advanced Forward Link Triangulation (AFLT) technique of gpsOne. The cell ID provides coordinates of a base station communicating with the mobile terminal, the U-TDOA uses a time difference or a phase difference of a signal being received from the plurality of base stations. The above-mentioned techniques perform position determination using wireless network data methods, minimize changes of a mobile terminal by not adding hardware (H/W), and add H/W and software (S/W) to the wireless network. Also, a spatiochromatic triangulation is developed to perform the position determination of the mobile terminal, the spatiochromatic triangulation converts a received signal strength (RRS) being received from the plurality of base stations to a distance.

Also, there is a database pattern matching technique, that is, a signal at each location, which is received from the plurality of base stations, is made into a database, the signal at each location is compared with a measured signal, and a present location of a mobile terminal is determined. However, when a location and a direction of the mobile terminal, and building locations in the surrounding area change, the changed information is required to be reflected, and when the database is required to be updated, an accuracy of position determination is decreased since the location of the mobile terminal is determined based on the base station.

Also, as another example, there is a handset-based position determination method, that is, a receiver such as a global positioning system (GPS) receiver is additionally joined with a mobile terminal. The handset-based position determination method determines a position of the mobile terminal using the signal receiver, and thereby an accuracy of a location is greater than the network-based method. However, a received signal is interfered with in an environment such as a forest, an underground location, a covered area of a tunnel, and an area in a city with buildings, and thereby the location of the mobile terminal may not be determined, also a required time for position determination may require more time than the network-based method.

As described above, the handset-based position determination method has greater accuracy for position determination than the network-based method, and a required time for position determination is greater, and thereby a user is required to unnecessarily spend more time even when the user does not require a precise location. Also, since the network-based position determination method has less accuracy for position determination than the handset-based position determination method, precise location data may not be provided when the precise location data is required.

Accordingly, there is a need for a new method which can provide a location based service capable of improving a conventional location based service.

### DISCLOSURE OF INVENTION

### Technical Goals

The present invention provides a location based service method and a location based service system which provides a client terminal with each location data including additional information, which is generated using position determination results according to a first position determination method and a second position determination method, in response to a location based service request.

The present invention also provides a location based service method that can be conveniently used by a user since a position determination result according to a first position determination method is provided to a client terminal, subsequently a position determination result according to a second position determination method is provided to the client terminal, the first position determination method having less accuracy and requiring less time, and the second position determination method having greater accuracy and requiring more time.

### Technical Solutions

According to an aspect of the present invention, there is provided a location based service method in a location based service system including: making requests for position determination of a client terminal according to a first position determination method and a second position determination method, in response to a location based service request; receiving a position determination result according to the first position determination method, and generating first location data including additional information which corresponds to the position determination result according to the first position determination method; providing the client terminal with the first location data; receiving a position determination result according to the second position determination method, and generating second location data, the second location data being refined first location data; and providing the client terminal with the second location data.

According to another aspect of the present invention, there is provided a location based method in a location based service system including: making a request for position determination of a client terminal according to a second position determination method, in response to a location based service request; receiving a position determination result according to a first position determination method from the client terminal, and generating first location data of the client terminal which includes additional information corresponding to the position determination result according to the first position determination method; providing the client terminal with the first location data; receiving a position determination result according to the second position determination method, and generating second location data, the second location data being refined first location data; and providing the client terminal with the second location data.

According to still another aspect of the present invention, there is provided a location based system including: a position determination request unit making requests for position determination of a client terminal according to a first position determination method and a second position determination method, in response to a location based service request; a first location data generation unit receiving a position determination result according to the first position determination method, and generating first location data including additional information which corresponds to the position determination result according to the first position determination method; a location data providing unit providing the client terminal with the first location data; a second location data generation unit receiving a position determination result according to the second position determination method, and generating second location data, the second location data being refined first location data, wherein the location data providing unit provides the client terminal with the second location data.

According to yet another aspect of the present invention, there is provided a location based system including: a position determination request unit making a request for position determination of a client terminal according to a second position determination method, in response to a location based service request; a first location data generation unit receiving a position determination result according to a first position determination method from the client terminal, and generating first location data of the client terminal which includes additional information corresponding to the position determination result according to the first position determination method; a location data generation unit providing the client terminal with the first location data; a second location data generation unit receiving a position determination result according to the second position determination method, and generating second location data, the second location data being refined first location data, wherein the location data providing unit provides the client terminal with the second location data.

### BRIEF DESCRIPTION OF DRAWINGS

FIGS. 1 through 3 are diagrams illustrating a network connection of a location based service which includes a location based service system according to an embodiment of the present invention;

FIG. 4 is a flowchart illustrating a location based service method according to an embodiment of the present invention;

FIG. 5 is a flowchart illustrating a location based service method according to an embodiment of the present invention;

FIG. 6 is a block diagram illustrating a location based service system according to an embodiment of the present invention; and

FIG. 7 is an internal block diagram illustrating a general-purpose computer which can be more adopted in implementing the location based service method according to an embodiment of the present invention.

### BEST MODE FOR CARRYING OUT THE INVENTION

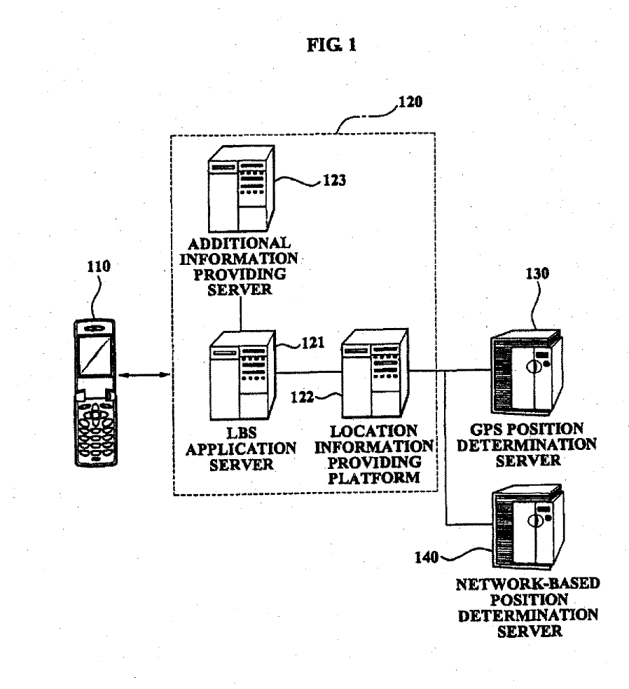

FIGS. 1 through 3 are diagrams illustrating a network connection of a location based service which includes a location based service system according to the present invention.

Referring to FIGS. 1 through 3, client terminals 110, 210, and 310 may include mobile communication devices, such as a Personal Digital Cellular (PDC) phone, a personal communication service (PCS) phone, a personal handyphone system (PHS) phone, a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a Digital Multimedia Broadcasting (DMB) phone, and a cellular phone; portable terminals such as a personal digital assistant (PDA), a hand-held PC, a notebook PC, a Wireless Broadband Internet (WiBro) terminal, and a Motion Picture Expert Group Audio Layer 3 (MP3) player; and all types of hand-held based wireless communication devices including an International Mobile Telecommunication (IMT)-2000 providing international roaming service and extended mobile communication service.

Referring to FIG. 1, the location based service system 120, in response to a location based service request, makes a request for position determination of a client terminal 110 according to a first position determination method to a network-based position determination server 140, and make a request for position determination of the client terminal 110 according to a second position determination method to a global positioning system (GPS)-based position determination server 130. In this instance, the location based service system 120 may include a location based service (LBS) application server 121, a location information providing platform 122, and an additional information providing server 123. The location based service system 120 receives a position determination result according to the first position determination method, and generates first location data including additional information which corresponds to the position determination result according to the first position determination method. In this instance, the location based service system 120 may generate the second location information which includes map data, point of interest (POI) data, real-time traffic information, statistics information associated with traffic, and routing information for road guidance by referring to an additional information providing server 133 which includes any one of a map server, a POI server, a real-time traffic information server, and a server for statistics information associated with traffic, and a routing information providing server. The location based service system 120 provides the client terminal 110 with the first location information, receives the position determination result according to the second position determination method from the GPS-based position determination server 130, generates second location data, the second location data being refined first location data, and provides the client terminal 110 with the second location data.

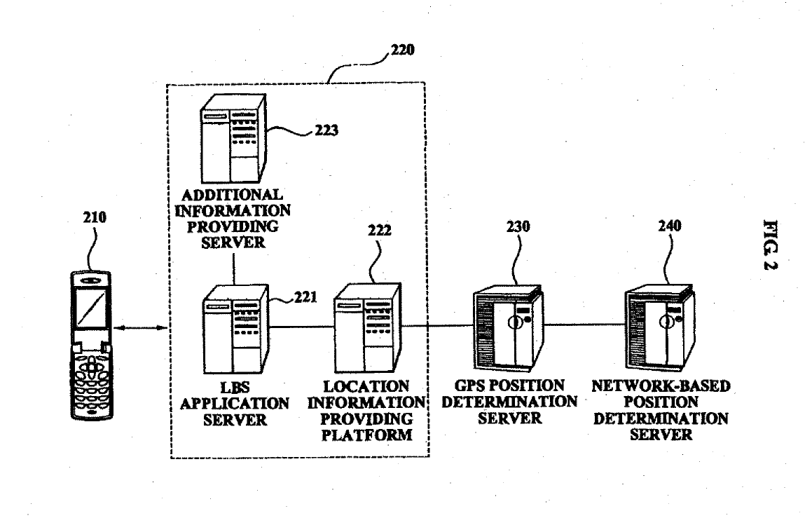

Referring to FIG. 2, a location based service system 220, in response to a location based service request, may make requests for position determination of a client terminal 210 according to a first position determination method, and requests for position determination of the client terminal 210 according to a second position determination method to a GPS-based position determination server 230, the GPS-based position determination server 230 may perform position determination of the client terminal 210 according to the second position determination method, and may make a request for the position determination of the client terminal 210 according to the first position determination method to the network-based position determination server 240.

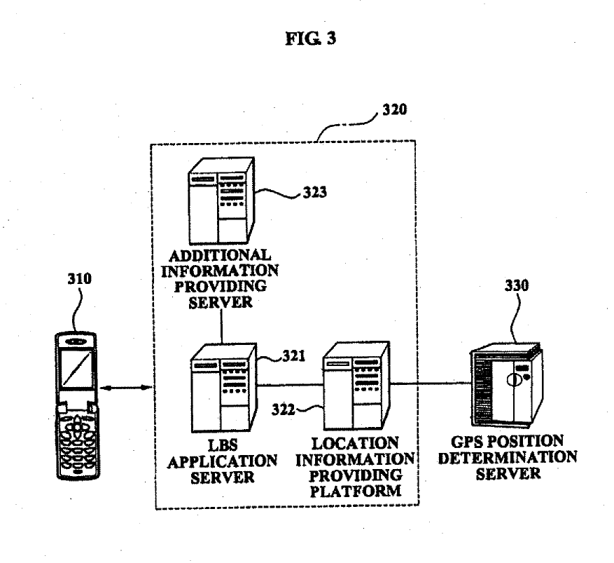

Also, referring to FIG. 3, a client terminal 310 may include a network-based position determination module, and a location based service system 320 may request, from a GPS-based position determination server 330, position determination of a client terminal 310 according to a second position determination method in response to a location based service request. The location based service system 320 may include an LBS application server 321, a location information providing platform 322, and an additional information providing server 323. In this instance, the client terminal 310 may perform position determination according to a first position determination using the network-based position determination module. The location based service system 320 may receive a position determination result according to the first position determination method from the client terminal 310, generate first location data including additional information which corresponds to the position determination result according to the first position determination method, and provide the client terminal 310 with the first location data. Also, the location based service system 320 may receive a position determination result according to the second position determination method from the GPS-based position determination server 330, refine the first location data to generate second location data, and provide the client terminal 310 with the second location data. In this instance, the location based service system 320 may refer to a map server 340, and may include the additional information, consequently may generate the second location data.

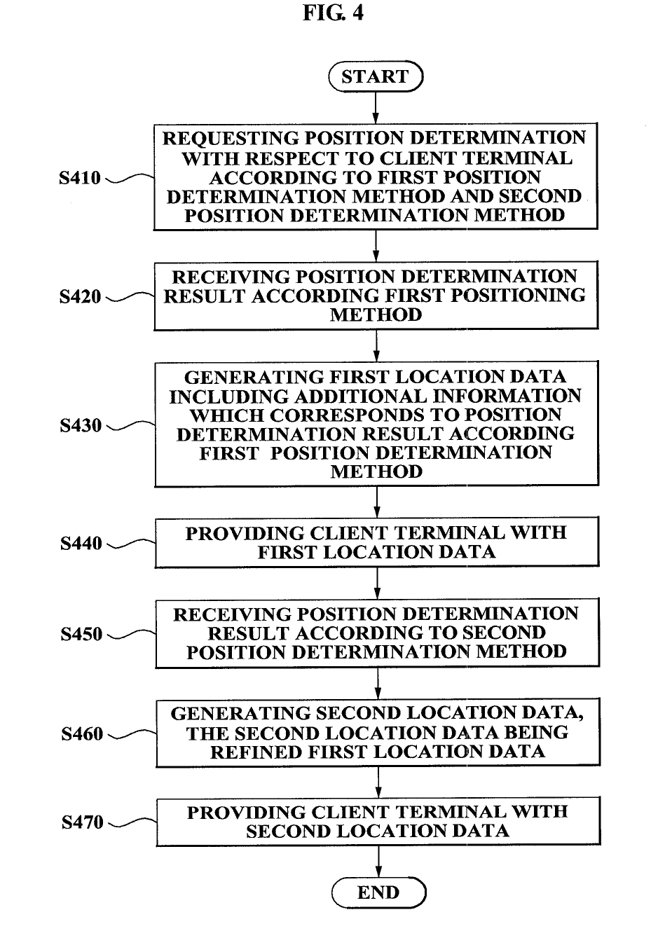

FIG. 4 is a flowchart illustrating a location based service method according to an embodiment of the present invention.

Referring to FIG. 4, in operation S410, the location based service method in a location based service system requests position determination of a client terminal according to a first position determination method and a second position determination method, in response to a location based service request. The location based service request may be requested by a user of the client terminal or a user of a second client terminal. As an example, a location inquiry service may be requested to inquire about the client terminal's own location from the client terminal, or may be requested to inquire a location of another client terminal from the client terminal.

According to an embodiment of the present invention, a required time for position determination of the first position determination method is less than a required time for position determination of the second position determination method, and an accuracy of the second position determination method is higher than an accuracy of the first position determination method.

Also, according to another embodiment of the present invention, the first position determination method is a network-based position determination method, and the second position determination method is a GPS-based position determination method. That is, since a required time for position determination of the network-based position determination method is generally less than a required time for position determination of the GPS-based position determination method, and an accuracy of the GPS-based position determination method is generally higher than an accuracy of the network-based position determination method, the network-based position determination method may be used for the first position determination method, and the GPS-based position determination method may be used for the second position determination method.

According to the current embodiment of the present invention, the location based service method in the location based service system may make a request for the position determination of the client terminal according to the first position determination method to the network-based position determination server, and make a request for the position determination of the client terminal according to the second position determination method to a GPS-based position determination server. Also, the client terminal may include an embedded GPS receiver, and the GPS-based position determination server may perform position determination of the client terminal via the GPS server embedded in the client terminal.

In operation S420, the location based service method in the location based service system receives a position determination result according to the first position determination method.

In operation S430, the location based service method in the location based service system generates first location data which includes additional information corresponding to the position determination result according to the first position determination method.

According to an embodiment of the present invention, the additional information may include map data to display the position determination results on the client terminal, point of interest (POI) data, real-time/non real-time traffic information, and routing information for road guidance. That is, the location based service method in the location based service system refers to an additional information providing server which includes at least one of a map server, a POI server, a real-time/non real-time traffic information providing server or a statistics information providing server, and a routing server, and generates the second location data which includes the map data, the POI data, the real-time/non real-time traffic information, and the routing information.

In operation S440, the location based service method in the location based service system provides the client terminal with the first location data, the client terminal having requested the location based service with respect to the first location data. That is, the location based service method in the location based service system receives the position determination result according to the first position determination method requiring comparatively less time for position determination, generates the first location data using the position determination result according to the first position determination method, and provides the client terminal with the first location data.

In operation S450, the location based service method in the location based service system receives the position determination result according to the second position determination method.

In operation S460, the location based service method in the location based service system generates the second location data, the second location data being generated by refining the first location data. That is, the location based service method in the location based service system refines the first location data with a less accuracy using the position determination result according to the second position determination method with a higher accuracy than the first position determination method, subsequently generates the second location data with a higher accuracy.

In operation S470, the location based service method in the location based service system provides the client terminal having requested the location based service with the second location data with the location data. That is, the location based service method in the location based service system initially provides the client terminal with the first location data, which is generated according to the first position determination method having less accuracy and requiring less time, subsequently provides the client terminal with the second location data, which is generated by refining the first location data using the second position determination method having greater accuracy and requiring more time, and consequently a user who has requested the location inquiry service may conveniently use the location inquiry service.

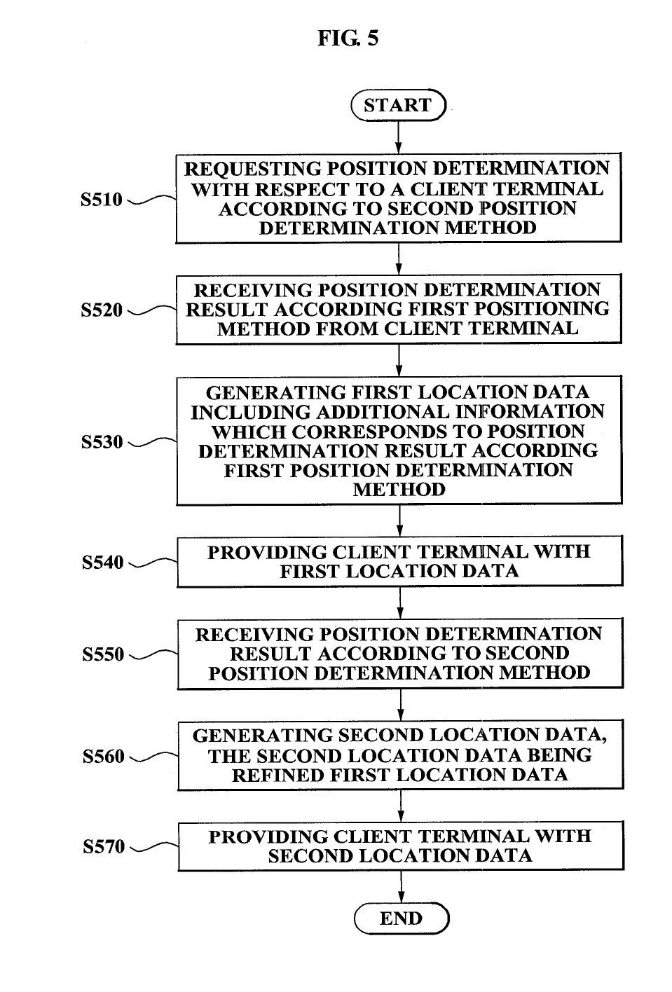

FIG. 5 is a flowchart illustrating a location based service method according to an embodiment of the present invention.

Referring to FIG. 5, in operation S510, the location based service method in a location based service system requests position determination of a client terminal according to a second position determination method, in response to a location based service request. The second position determination method may be a GPS-based position determination method.

According to the above embodiment of the present invention, the location based service method in a location based service system may make a request for the position determination of the client terminal according to the GPS-based position determination method of the second position determination method to a GPS position determination server.

In operation S520, the location based service method in the location based service system receives a position determination result according to the first position determination method from the client terminal. Also, according to another embodiment of the present invention, the client terminal may include a network-based position determination module.

In operation S530, the location based service method in the location based service system generates first location data of the client terminal which includes additional information corresponding to the position determination result according to the first position determination method.

According to an embodiment of the present invention, a required time for position determination of the first position determination method is less than a required time for position determination of the second position determination method, and an accuracy of the second position determination method is higher than an accuracy of the first position determination method.

According to another embodiment of the present invention, the location based service method in the location based service system may receive the position determination result, which is acquired using the network-based position determination module, from the client terminal and may generate the first location data of the client terminal which includes the additional information. As an example, according to the location based service request, the client terminal may perform the position determination of the client terminal according to the first position determination method using the network-based position determination module, and the location based service method in the location based service system may receive the position determination result, which is acquired using the network-based position determination module, from the client terminal.

According to still another embodiment of the present invention, the additional information may include map data to display the position determination result on the client terminal, POI data, real-time traffic information, statistics information associated with traffic, and routing information for road guide.

In operation S540, the location based service method in the location based service system provides the client terminal having requested the location based service with the first location data. That is, the location based service method in the location based service system provides the client terminal with the first location data, which is generated using the position determination result according to the first position determination method.

In operation S550, the location based service method in the location based service system receives a position determination result according to the second position determination method.

In operation S560, the location based service method in the location based service system generates second location data by refining the first location data. As an example, the location based service method in the location based service system receives the position determination result according to a GPS position determination method of the second position determination method from the GPS position determination server, and generates the second location data by refining the second location data.

In operation S570, the location based service method in the location based service system provides the client terminal with the second location data. That is, the location based service method in the location based service system initially provides the client terminal with the first location data, which is generated according to the first position determination method having less accuracy and requiring less time, subsequently provides the client terminal with the second location data, which is generated by refining the first location data using the second position determination method having greater accuracy and requiring more time.

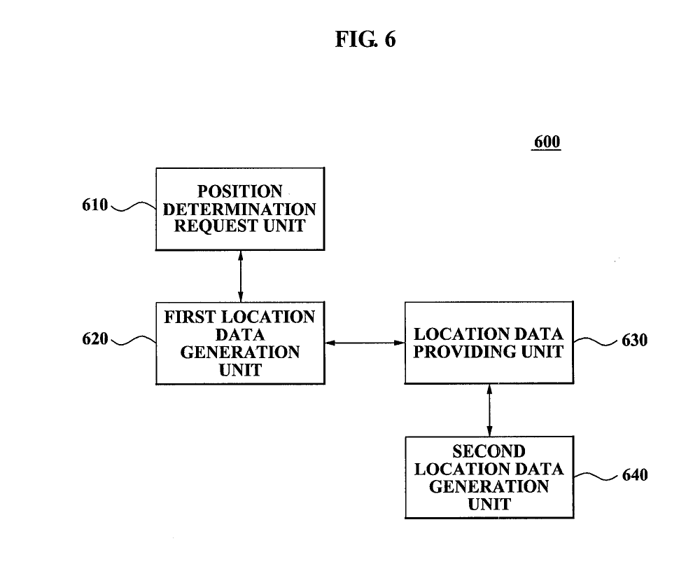

FIG. 6 is a block diagram illustrating a location based service system 600 according to an embodiment of the present invention.

As illustrated in FIG. 6, the location based service system 600 includes a position determination request unit 610, a first location data generation unit 620, a location data providing unit 630, and a second location data generation unit 640.

Referring to FIGS. 1 through 6, the position determination request unit 610 of the location based service system 600 may be included in the location-based service application server 121 or the location information providing platform 122, the first location data generation unit 620 and the second location data generation unit 640 may be included in any one of the location based service application server 121, the location information providing platform 122, and the additional information providing server 123, and the location data providing unit 630 may be included in the location-based service application server 121. The first location data generation unit 620 may be included in the network-based position determination server 140, and the second location data generation unit 640 may be included in the GPS-based position determination server 130.

Referring to FIG. 6, the position determination request unit 610 requests position determination of a client terminal according to a first position determination method and a second position determination method, in response to a location based service request. The location based service request may be requested by a user of the client terminal or a user of a second client terminal. As an example, a location inquiry service may be requested to inquire about “my location” from the client terminal, or may be requested to inquire about a location of another client terminal by the client terminal.

According to an embodiment of the present invention, a required time for position determination of the first position determination method is less than a required time for position determination of the second position determination method, and an accuracy of the second position determination method is higher than an accuracy of the first position determination method.

Also, according to another embodiment of the present invention, the first position determination method is a network-based position determination method, and the second position determination method is a GPS-based position determination method. That is, since a required time for position determination of the network-based position determination method is generally less than a required time for position determination of the GPS-based position determination method, and an accuracy of the GPS-based position determination method is generally higher than an accuracy of the network-based position determination method, the network-based position determination method may be used for the first position determination method, and the GPS-based position determination method may be used for the second position determination method.

According to the above embodiment of the present invention, the position determination request unit 610 may request, from the network based position determination server, the position determination of the client terminal according to the first position determination method, and may request, from a GPS-based position determination server, the position determination of the client terminal according to the second position determination method.

The first location data generation unit 620 receives a position determination result according to the first position determination method, and generates first location data of the client terminal which includes additional information corresponding to the position determination result according to the first position determination method. According to the above embodiment of the present invention, the additional information may include map data to display the position determination result on the client terminal, POI data, real-time traffic information, statistics information associated with traffic, and routing information for road guide.

The location data providing unit 630 provides the client terminal having requested the location based service with the first location data.

The second location data generation unit 640 receives the position determination result according to the second position determination method, and generates the second location data, the second location data being refined first location data.

The location data providing unit 630 provides the client terminal with the second location data. That is, the location data providing unit 630 initially provides the client terminal with the first location data, which is generated according to the first position determination method having less accuracy and requiring less time, subsequently provides the client terminal with the second location data, which is generated by refining the first location data using the second position determination method having greater accuracy and requiring more time, and consequently a user who has requested the location inquiry service may conveniently use the location inquiry service.

A location based service system according to another embodiment of the present invention will be described by referring to the diagram of FIG. 6.

Referring to FIG. 6, the position determination request unit 610 requests position determination of a client terminal according to a second position determination method, in response to a location based service request. According to an embodiment of the present invention, the second position determination method may be a GPS-based position determination method.

According to the above embodiment of the present invention, the position determination request unit 610 may request, from a GPS position determination server, the position determination of the client terminal according to the GPS-based position determination method of the second position determination method.

The position determination request unit 610 receives a position determination result according to the first position determination method from the client terminal, and generates first location data of the client terminal which includes additional information corresponding to the position determination result according to the first position determination method.

According to an embodiment of the present invention, a required time for position determination of the first position determination method is less than a required time for position determination of the second position determination method, and accuracy of the second position determination method is higher than accuracy of the first position determination method.

According to another embodiment of the present invention, the first location data generation unit 620 may receive the position determination result, which is acquired using the network-based position determination module, from the client terminal and may generate the first location data of the client terminal which includes the additional information.

Also, according to still another embodiment of the present invention, the additional information may include map data to display the position determination result on the client terminal, POI data, real-time traffic information, statistics information associated with traffic, and routing information for road guide.

The location data providing unit 630 provides the client terminal with the first location data.

The second location data generation unit 640 receives a position determination result according to the second position determination method, and generates second location data by refining the first location data.

The location data providing unit 630 provides the client terminal with the second location data.

The location based service method in the location based service system for providing a user-customized recommended word according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

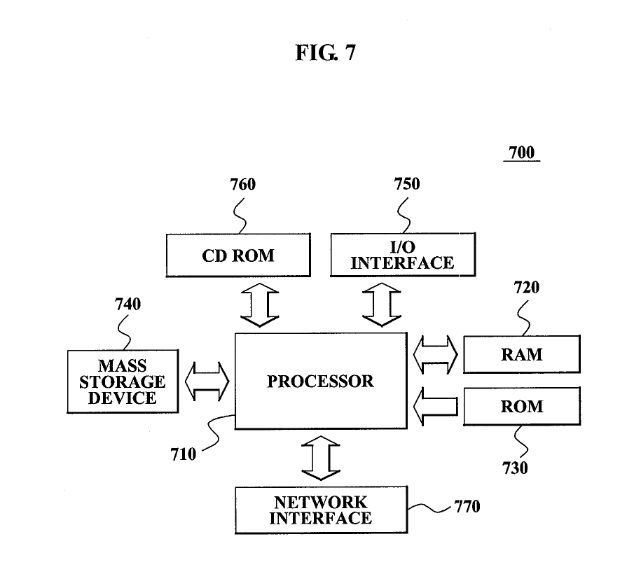

FIG. 7 is an internal block diagram illustrating a general-purpose computer apparatus 700 which can be adopted in implementing the location based service method according to an embodiment of the present invention.

The computer apparatus 700 which includes at least one processor 710 connected to a main memory device including a RAM (Random Access Memory) 720 and a ROM (Read Only Memory) 730. The processor 710 is also known as a central processing unit CPU. As well-known in the field of the art, the ROM 730 unidirectionally transmits data and instructions to the CPU, and the RAM 720 is generally used for bidirectionally transmitting data and instructions. The RAM 720 and the ROM 730 may include a certain proper form of a computer-readable recording medium. A mass storage device 740 is bidirectionally connected to the processor 710 to provide additional data storage capacity and may be one of number of computer-readable recording mediums. The mass storage device 740 is used for storing programs and data and is an auxiliary memory. A particular mass storage device such as a CD ROM 760 may be used. The processor 710 is connected to at least one input/output interface 750 such as a video monitor, a track ball, a mouse, a keyboard, a microphone, a touch-screen type display, a card reader, a magnetic or paper tape reader, a voice or hand-writing recognizer, a joystick, or other known computer input/output unit. The processor 710 may be connected to a wired or wireless communication network via a network interface 770. The procedure of the described method can be performed via the network connection. The described devices and tools are well-known to those skilled in the art of computer hardware and software. The described hardware devices may be configured to act as one or more software modules in order to perform the operations of the present invention.

### INDUSTRIAL APPLICABILITY

According to the present invention, there is provides a provided a location based service method and location based service system which provides a client terminal with each location data including additional information, which is generated using position determination results according to a first position determination method and a second position determination method, in response to a location based service request.

Also, according to the present invention, there is a provided location based service method that can be conveniently used by a user since a position determination result according to a first position determination method is provided to a client terminal, subsequently a position determination result according to a second position determination method is provided to the client terminal, the first position determination method having less accuracy and requiring less time, and the second position determination method having greater accuracy and requiring more time.

Although a few embodiments of the present invention have been shown and described, the present invention is not limited to the described embodiments.

Instead, it would be appreciated by those skilled in the art that changes may be made to these embodiments without departing from the principles and spirit of the invention, the scope of which is defined by the claims and their equivalents.

1. A location based service method, comprising:
making requests for position determination of a client terminal according to a first position determination method and a second position determination method, in response to a location based service request;
receiving a position determination result according to the first position determination method, and generating first location data including additional information which corresponds to the position determination result according to the first position determination method;
providing the client terminal with the first location data;
receiving a position determination result according to the second position determination method, and generating second location data, the second location data being refined first location data; and
providing the client terminal with the second location data.

2. The method of claim 1, wherein a required time for position determination of the first position determination method is less than a required time for position determination of the second position determination method, and accuracy of the second position determination method is higher than an accuracy of the first position determination method.

3. The method of claim 2, wherein the first position determination method is a network-based position determination method, and the second position determination method is a global positioning system (GPS)-based position determination method.

4. The method of claim 3, wherein the making of the requests for the position determination according to the first position determination method and the second position determination method of the client terminal makes a request for the position determination of the client terminal according to the first position determination method to a network-based position determination server, and makes a request for the position determination of the client terminal according to the second position determination method to a GPS-based position determination server.

5. The method of claim 1, wherein the additional information comprises at least one of: map data, point of interest (POT) data, real-time/non real-time traffic information, and routing information.

6. A location based service method, comprising:
making a request for position determination of a client terminal according to a second position determination method, in response to a location based service request;
receiving a position determination result according to a first position determination method from the client terminal, and generating first location data of the client terminal which includes additional information corresponding to the position determination result according to the first position determination method;
providing the client terminal with the first location data;
receiving a position determination result according to the second position determination method, and generating second location data, the second location data being refined first location data; and
providing the client terminal with the second location data.

7. The method of claim 6, wherein a required time for position determination of the first position determination method is less than a required time for position determination of the second position determination method, and an accuracy of the second position determination method is higher than an accuracy of the first position determination method.

8. The method of claim 6, wherein the client terminal comprises a network-based position determination module, and the generating of first location data of the client terminal receives the position determination result, which is position-determined using the network based position determination module, from the client terminal, and generates the first location data of the client terminal which includes the additional information.

9. The method of claim 6, wherein the second position determination method is a GPS-based position determination method, and the making of the request of the position determination according to the second position determination method makes a request for the position determination of the client terminal according to the second position determination method of the GPS-based position determination method to the GPS-based position determination server.

10. The method of claim 6, wherein the additional information comprises at least one of: map data, point of interest (POI) data, real-time/non real-time traffic information, and routing information.

11. A computer-readable storage medium storing a program for implementing a location based service method of any one of claims 1 through 10.

12. A location based service system, comprising:
a position determination request unit making requests for position determination of a client terminal according to a first position determination method and a second position determination method, in response to a location based service request;
a first location data generation unit receiving a position determination result according to the first position determination method, and generating first location data including additional information which corresponds to the position determination result according to the first position determination method;
a location data providing unit providing the client terminal with the first location data;
a second location data generation unit receiving a position determination result according to the second position determination method, and generating second location data, the second location data being refined first location data,
wherein the location data providing unit provides the client terminal with the second location data.

13. The system of claim 12, wherein a required time for position determination of the first position determination method is less than a required time for position determination of the second position determination method, and an accuracy of the second position determination method is higher than an accuracy of the first position determination method.

14. The system of claim 12, wherein the first position determination method is a network-based position determination method, and the second position determination method is a global positioning system (GPS)-based position determination method.

15. The system of claim 14, wherein the position determination request unit makes a request for the position determination of the client terminal according to the first position determination method to a network-based position determination server, and makes a request for the position determination of the client terminal according to the second position determination method to a GPS-based position determination server.

16. The system of claim 12, wherein the additional information comprises at least one of: map data, point of interest (POI) data, real-time/non real-time traffic information, and routing information.

17. A location based service method, comprising:
a position determination request unit making a request for position determination of a client terminal according to a second position determination method, in response to a location based service request;
a first location data generation unit receiving a position determination result according to a first position determination method from the client terminal, and generating first location data of the client terminal which includes additional information corresponding to the position determination result according to the first position determination method;
a location data generation unit providing the client terminal with the first location data;
a second location data generation unit receiving a position determination result according to the second position determination method, and generating second location data, the second location data being refined first location data,
wherein the location data providing unit provides the client terminal with the second location data.

18. The system of claim 17, wherein a required time for position determination of the first position determination method is less than a required time for position determination of the second position determination method, and an accuracy of the second position determination method is higher than an accuracy of the first position determination method.

19. The system of claim 17, wherein the client terminal comprises a network-based position determination module, and the first location data generation unit receives the position determination result, which is position-determined using the network based position determination module, from the client terminal, and generates the first location data of the client terminal which includes the additional information.

20. The system of claim 17, wherein the second position determination method is a GPS-based position determination method, and the position determination request unit makes a request for the position determination of the client terminal according to the second position determination method to the GPS-based position determination server.

21. The system of claim 17, wherein the additional information comprises at least one of: map data, point of interest (POI) data, real-time/non real-time traffic information, and routing information.
